(19) United States
(12) Patent Application Publication
(10) Pub. No.: US 2025/0052613 A1
(43) Pub. Date: Feb. 13, 2025

(54) SPECTROPHOTOMETER

(71) Applicant: SHIMADZU CORPORATION, Kyoto (JP)

(72) Inventor: Takahiro TAMAKI, Kyoto (JP)

(73) Assignee: SHIMADZU CORPORATION, Kyoto (JP)

(21) Appl. No.: 18/718,017

(22) PCT Filed: Jun. 3, 2022
(86) PCT No.: PCT/JP2022/022588

§ 371 Date: Jun. 8, 2024

(30) Foreign Application Priority Data
Dec. 14, 2021 (JP) 2021-202853

(51) Int. Cl. G01J 3/30; G01J 3/02; G01J 3/10; G01J 3/42

(52) U.S. Cl. CPC G01J 3/30; G01J 3/0218; G01J 3/10; G01J 3/42; G01J 2003/421

(57) ABSTRACT

A spectrophotometer includes: a light source configured to emit light in a wavelength band including an excitation wavelength which causes a photoreaction on a target substance in a sample, the light source emitting a known number of photons of the light having the excitation wavelength; an integrating sphere having a light entrance port through which light emitted from the light source enters and a light emission port provided at a position deviated from an optical axis of the light entering the light entrance port; a sample placement unit provided in the light entrance port; and a light intensity measurement unit configured to measure intensity of light having the excitation wavelength emitted from the light emission port.

### TECHNICAL FIELD

The present invention relates to a spectrophotometer.

### BACKGROUND ART

In order to evaluate the reaction efficiency of a photoreactive material such as a photocatalyst, an index called photoreaction quantum yield is used. The photoreaction quantum yield is calculated as a ratio of the number of molecules generated by photoreaction of the photoreactive material to the number of photons absorbed by the photoreactive material. The number of photons absorbed by the photoreactive material is measured by a spectrophotometer, and the number of molecules generated by photoreaction of the photoreactive material is measured by a gas chromatograph or a liquid chromatograph.

Patent Literature 1 describes a spectrophotometer used to measure the number of photons absorbed by a photoreactive material. This device includes a sample cell, an excitation light source which irradiates the sample cell with excitation light, a measurement light source which irradiates the sample cell with measurement light, and a spectroscopic detection unit which wavelength-separates and detects the measurement light passing through the sample cell. These units are disposed such that the optical path of the excitation light and the optical path of the measurement light are orthogonal to each other. The excitation light source is a monochromatic light source such as an LED, and the measurement light source is a white light source such as a xenon lamp. As the excitation light source, such a light source that the number of photons (number of irradiation photons) emitted from the light source and irradiated on the sample is known by preliminary measurement using an illuminometer or the like is used.

In the spectrophotometer of Patent Literature 1, first, a sample cell containing a sample is irradiated with only measurement light, and the transmitted light is detected to obtain a first absorbance spectrum. Subsequently, the sample cell is irradiated with excitation light, and while the sample cell is irradiated with excitation light, the sample cell is irradiated with the measurement light in the same manner as above-described. The transmitted light is detected to obtain a second absorbance spectrum. The difference between the first absorbance spectrum and the second absorbance spectrum corresponds to a change in light absorptivity due to the reaction of the photoreactive material in the sample. The number of photons per unit time absorbed by the photoreactive material in the sample is determined by the product of the number of irradiated photons irradiated during a unit time and the change in the light absorptivity of the photoreactive material.

### CITATION LIST

### Patent Literature

Patent Literature 1: WO 2021/166310 A

### Non Patent Literature

Non Patent Literature 1: Standard LED, [online], Nichia Corporation, [searched on Nov. 9, 2021], Internet <URL: https://www.nichia.co.jp/jp/product/sled.html>

### SUMMARY OF INVENTION

### Technical Problem

Photoreactive materials are used in various products such as cosmetics and semiconductor photocatalysts, and they are used in various states and forms such as in a sol, in a gel, and in a thin film. However, in the spectrophotometer described in Patent Literature 1, when a heterogeneous liquid sample such as a sol or a get or a thin film sample is irradiated with measurement light, a part of light passing through the sample is scattered (forward scattered), and a correct light absorptivity cannot be obtained. Therefore, the conventional spectrophotometer has the problem that the measurement target is limited only to a homogeneous liquid sample in which such light scattering does not occur.

An object of the present invention is to provide a spectrophotometer that can measure the number of photons of light absorbed by a heterogeneous liquid sample or thin film sample.

### Solution to Problem

A spectrophotometer according to the present invention made to solve the above-described problems includes:
a light source configured to emit light in a wavelength band including an excitation wavelength which causes a photoreaction on a target substance in a sample, the light source emitting a known number of photons of the light having the excitation wavelength;
an integrating sphere having a light entrance port through which light emitted from the light source enters and a light emission port provided at a position deviated from an optical axis of the light entering the light entrance port;
a sample placement unit provided in the light entrance port; and
a light intensity measurement unit configured to measure intensity of light having the excitation wavelength emitted from the light emission port.

### Advantageous Effects of Invention

In the spectrophotometer according to the present invention, one light source having both functions of a conventional excitation light source and a measurement light source is used. In this spectrophotometer, first, light is emitted from a light source without placing a sample in a sample placement unit, and the intensity of light having an excitation wavelength is measured by a light intensity measurement unit. Subsequently, the sample is placed in the sample placement unit provided in the light entrance port of the integrating sphere, and light is emitted from the light source. In the spectrophotometer according to the present invention, the absorptivity of the excitation wavelength light of the target substance contained in the sample is obtained on the basis of the intensity of the excitation wavelength light when the sample is not placed and the intensity of the excitation wavelength light when the sample is placed. Furthermore, the number of photons per unit time of the excitation wavelength light absorbed by the target substance is calculated from the product of the number of photons per unit time of the excitation wavelength light emitted from the light source and the absorptivity of the light. In the spectrophotometer according to the present invention, the intensity of light having an excitation wavelength included in transmitted light including forward scattered light by the sample is measured by the light intensity measurement unit, and the absorbance is obtained on the basis of the intensity, so that the number of photons of light absorbed by the heterogeneous liquid sample or thin film sample can be measured.

### BRIEF DESCRIPTION OF DRAWINGS

FIG. 1 is a schematic configuration diagram of an embodiment of a spectrophotometer according to the present invention.

FIG. 2 is a diagram illustrating a configuration when total energy of light emitted from a light source unit is measured.

FIG. 3 is a flowchart of an example of a measurement procedure using the spectrophotometer of the present embodiment.

### DESCRIPTION OF EMBODIMENTS

An embodiment of a spectrophotometer according to the present invention will be described below with reference to the drawings. A spectrophotometer 1 according to the present invention is used to calculate the number of photons of light absorbed by a photoreactive material such as a photocatalyst, which is necessary for calculating the photoreaction quantum yield of the photoreactive material.

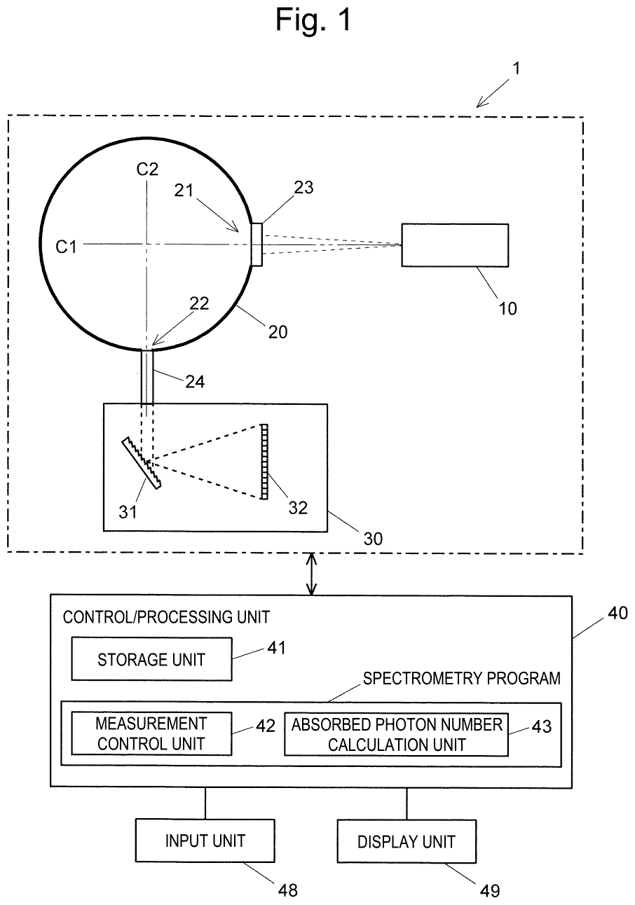

FIG. 1 shows a schematic configuration of the spectrophotometer 1 of the present embodiment. The spectrophotometer 1 includes a light source 10, an integrating sphere 20, a spectroscopic detection unit 30, and a control/processing unit 40.

The light source 10 emits light in a wavelength band including an excitation wavelength that causes a photoreaction on a target substance (photoreactive material) contained in a sample to be measured. In the present embodiment, a light source called a white LED (for example, a spectral total radiant flux standard LED described in Non Patent Literature 1) is used as the light source 10.

The integrating sphere 20 has a light entrance port 21 through which light emitted from the light source 10 enters, and a light emission port 22 through which light is emitted from the inside of the integrating sphere 20. The integrating sphere 20 of the present embodiment is provided with the light entrance port 21 and the light emission port 22 such that a central axis C1 of light emitted from the light source 10 and entering the light entrance port 21 and a central axis C2 of light emitted from the light emission port 22 to the spectroscopic detection unit 30 are orthogonal to each other. The light entrance port 21 is provided with a sample placement unit 23. The sample placement unit 23 includes a sample cell that stores a liquid sample and a mechanism for fixing a film-shaped sample. In addition, the light emission port 22 and the entrance of the spectroscopic detection unit 30 are connected by an optical fiber 24.

The spectroscopic detection unit 30 includes a spectroscope 31 which wavelength-separates the light emitted from the light emission port 22 and a photodetector 32 which detects the light wavelength-separated by the spectroscope 31. For example, a diffraction grating is used as the spectroscope 31. As the photodetector 32, for example, a linear sensor including a plurality of detection elements arranged in a direction in which the wavelength-separated light spreads is used.

The control/processing unit 40 includes a storage unit 41. The storage unit 41 stores data such as total energy of light emitted from the light source 10, an emission spectrum, and the number of photons for each wavelength. In addition, the control/processing unit 40 includes a measurement control unit 42 and an absorbed photon number calculation unit 43 as functional blocks. An entity of the control/processing unit 40 is a general computer, and the above-described functional blocks are embodied by executing a spectrometry program installed in advance. Furthermore, the control/processing unit 40 is connected with an input unit 48 such as a keyboard and a mouse and a display unit 49 such as a liquid crystal display.

Next, a procedure for measuring the number of photons of light absorbed by the photoreaction of the target substance in the sample using the spectrophotometer 1 of the present embodiment will be described with reference to the flowchart of FIG. 3.

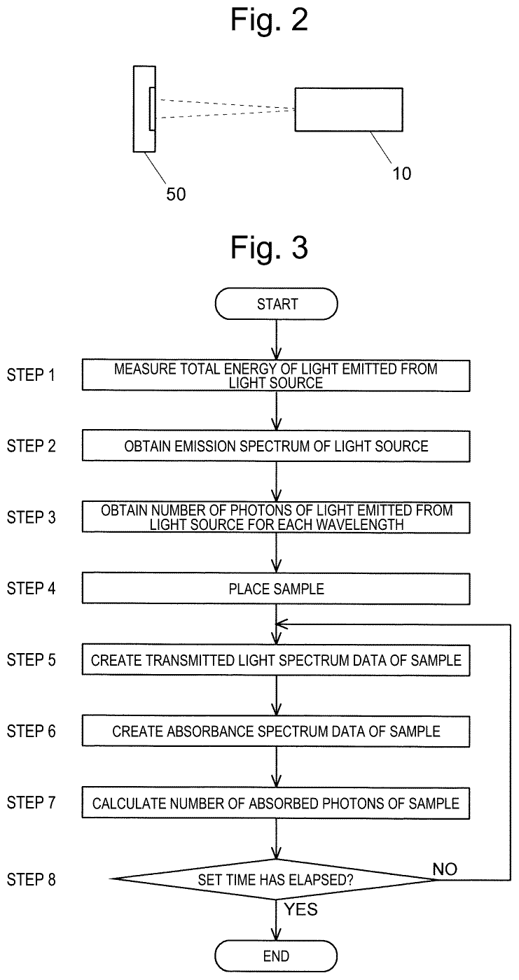

Before measuring the sample to be analyzed, the number of photons of the light having the excitation wavelength emitted from the light source 10 is obtained. Here, first, the total energy of the light emitted from the light source 10 is measured (Step 1). As illustrated in FIG. 2, this measurement is performed by allowing light emitted from the light source 10 to be incident on an illuminometer (also referred to as power sensor) 50.

Subsequently, the light source 10 is returned to the position illustrated in FIG. 1 (however, no sample is placed), the light emitted from the light source 10 is incident on the integrating sphere 20 from the light entrance port 21, and the light emitted from the light emission port 22 of the integrating sphere 20 is introduced into the spectroscopic detection unit 30. In the spectroscopic detection unit 30, the introduced light is wavelength-separated by the spectroscope 31, and the intensity of each wavelength is measured by the photodetector 32. As a result, an emission spectrum (intensity of light per wavelength per unit time) of the light source 10 is obtained (Step 2).

Thereafter, on the basis of the total energy of the light emitted from the light source 10 obtained in Step 1, the emission spectrum of the light source 10 obtained in Step 2, and the energy (hc/λ, where h is Planck's constant, c is the speed of light, and λ is wavelength) of one photon at each wavelength, the number of photons of the light emitted from the light source 10 for each wavelength is calculated (Step 3) and stored in the storage unit 41. As long as a change in the emission spectrum due to deterioration of the light source 10 or the like does not occur, Steps 1 to 3 may be performed once when the light source 10 is installed to store data of the number of photons for each wavelength in the storage unit 41, and it is not necessary to perform Steps 1 to 3 every time the sample is measured.

Next, when a user places the sample in the sample placement unit 23 (Step 4) and instructs to start the measurement, the measurement control unit 42 irradiates the sample with light from the light source 10. The light transmitted through the sample enters the inside of the integrating sphere 20 from the light entrance port 21, is reflected one or more times, then is introduced into the optical fiber 24 from the light emission port 22, and enters the spectroscopic detection unit 30. The light incident on the spectroscopic detection unit 30 is wavelength-separated by the spectroscope 31 and detected by the photodetector 32. The photodetector 32 outputs a signal indicating the intensity of light having each wavelength incident on each detection element of the photodetector 32.

The measurement control unit 42 reads an output signal (data of the intensity of light detected by each detection element) from the photodetector 32 and stores the read signal in the storage unit 41. When data is newly stored in the storage unit 41, the absorbed photon number calculation unit 43 creates transmitted light spectrum data from the data (Step 5).

After creating the transmitted light spectrum data, the absorbed photon number calculation unit 43 further creates absorbance spectrum data from the light emission spectrum data obtained in Step 2 and the transmitted light spectrum data obtained in Step 5 (Step 6), and displays the absorbance spectrum on the screen of the display unit 49.

When the absorbance spectrum data is obtained, the absorbed photon number calculation unit 43 calculates the number of absorbed photons by the following formula (Step 7).

$$[ First formula ]$$

$$Total number of absorbed photons = \int \int Ei ( λ , t ) \times [ 1 - T ( λ , t ) ] \frac{λ}{hc} d λ dt \qquad ( 1 )$$

Here, Ei is the irradiation light intensity per unit time, T is the transmittance of the sample, and t is time. In addition, the wavelength range integrated in the above formula (1) is substantially the same as (for example, +10 nm centered on the excitation wavelength of the target substance) the peak in the absorbance spectrum.

When the number of absorbed photons is calculated by the above formula (1), the value is displayed on the screen of the display unit 49 together with the absorbance spectrum data.

The measurement control unit 42 determines whether the elapsed time from the start of measurement has reached a time set in advance by the user. If the elapsed time from the start of measurement has not yet reached the set time (NO in Step 8), the processing returns to Step 5 and the same processing as above-described is performed. When the elapsed time from the start of the measurement has reached the set time (YES in Step 8), the measurement is ended.

In a conventional spectrophotometer, a sample enclosed in a sample cell is irradiated with light from a measurement light source, and the intensity of light passing through the sample cell is measured by a spectroscopic detector. Therefore, it is not possible to measure a sample (for example, a heterogeneous liquid sample or a film-shaped sample) that scatters measurement light passing through the sample (sample cell).

In contrast, in the spectrophotometer 1 of the present embodiment, one light source 10 that also functions as a measurement light source and an excitation light source in the conventional spectrophotometer is used. In addition, the integrating sphere 20 is used, the sample placement unit 23 is provided at the light entrance port 21, and the sample is placed in the sample placement unit 23. By adopting such a placement, even if forward scattering occurs in light passing through the sample placed in the sample placement unit 23, the light is made incident on the integrating sphere 20, reflected one or more times inside, and made incident on the spectroscopic detection unit 30. Therefore, it is possible to calculate the number of absorbed photons at the time of photoreaction of the target substance contained in a heterogeneous liquid sample or film-shaped sample, which cannot be measured by a conventional spectrophotometer.

The above-described embodiment is merely an example, and can be appropriately modified in accordance with the spirit of the present invention.

In the above-described embodiment, the white LED is used as the light source 10, but another type of white light source may be used. In addition, a monochromatic light source can also be used as the light source 10. In a case where a monochromatic light source is used as the light source 10, since light emitted from the integrating sphere 20 is also monochromatic light, it is not necessary to use a spectroscopic element, and a photodetector having only a single detection element can be used instead of the spectroscopic detection unit 30. When a monochromatic light source is used as the light source 10, light is emitted from the monochromatic light source from the light source 10 in a state where the sample is not placed in the sample placement unit 23 and in a state where the sample is placed, intensity of light having a single wavelength emitted from the integrating sphere 20 is measured, and an absorptivity of light at the wavelength is obtained.

In the above-described embodiment, the integrating sphere 20 in which the light entrance port 21 and the light emission port 22 are provided such that the central axis of the light entering the light entrance port 21 from the light source 10 and the central axis of the light taken into the optical fiber 24 from the light emission port 22 are orthogonal to each other is used. However, the light entrance port 21 and the light emission port 22 may be provided at appropriate positions as long as the light emission port 22 is not positioned on the central axis of the light entering the light entrance port 21 from the light source 10.

### MODES

It is understood by those skilled in the art that the plurality of exemplary embodiments described above are specific examples of the following modes.

### (Clause 1)

A spectrophotometer according to one mode of the present invention includes:
a light source configured to emit light in a wavelength band including an excitation wavelength which causes a photoreaction on a target substance in a sample, the light source emitting a known number of photons of the light having the excitation wavelength;
an integrating sphere having a light entrance port through which light emitted from the light source enters and a light emission port provided at a position deviated from an optical axis of the light entering the light entrance port;
a sample placement unit provided in the light entrance port; and
a light intensity measurement unit configured to measure intensity of light having the excitation wavelength emitted from the light emission port.

In the spectrophotometer according to Clause 1, one light source having both functions of a conventional excitation light source and a measurement light source is used. In this spectrophotometer, first, light is emitted from a light source without placing a sample in a sample placement unit, and the intensity of light having an excitation wavelength is measured by a light intensity measurement unit. Subsequently, the sample is placed in the sample placement unit provided in the light entrance port of the integrating sphere, and light is emitted from the light source. In the spectrophotometer according to Clause 1, the absorptivity of the light having the excitation wavelength of the target substance contained in the sample is obtained on the basis of the intensity of the excitation wavelength light when the sample is not placed and the intensity of the excitation wavelength light when the sample is placed. Furthermore, the number of photons of the excitation wavelength light absorbed by the target substance is calculated from the product of the number of photons of the excitation wavelength light emitted from the light source and the absorptivity of the light. In the spectrophotometer according to Clause 1, the intensity of light having an excitation wavelength included in transmitted light including forward scattered light by the sample is measured by the light intensity measurement unit, and the absorbance is obtained on the basis of the intensity, so that the number of photons of light absorbed by the heterogeneous liquid sample or thin film sample can be measured.

### (Clause 2)

The spectrophotometer according to Clause 1, further includes
an arithmetic processing unit configured to calculate an absorptivity of the light having the excitation wavelength by the target substance on a basis of the intensity of the light having the excitation wavelength detected by the detection unit in a state where the sample is not placed in the sample placement unit and the intensity of the light having the excitation wavelength detected by the detection unit in a state where the sample is placed in the sample placement unit.

### (Clause 3)

In the spectrophotometer according to Clause 2,
the arithmetic processing unit is further configured to calculate the number of photons of the light absorbed by the target substance on a basis of the number of photons and the absorptivity of the light having the excitation wavelength.

The spectrophotometer according to Clause 2 can easily obtain the absorptivity of the light having the excitation wavelength by the target substance, and the spectrophotometer according to Clause 3 can easily obtain the number of photons of the light having the excitation wavelength absorbed by the target substance.

### (Clause 4)

In the spectrophotometer according to any one of Clauses 1 to 3,
the light source is a white LED light source, and
the light intensity measurement unit includes a spectroscope configured to wavelength-separate light emitted from the light emission port, and a photodetector configured to detect the light wavelength-separated by the spectroscope.

In the spectrophotometer of Clause 4, an absorbance spectrum in a wavelength band including an excitation wavelength is obtained, and the number of photons of light absorbed by the target substance can be calculated on the basis of a peak of absorbance around the wavelength band.

### REFERENCE SIGNS LIST

1 . . . Spectrophotometer
10 . . . Light Source
20 . . . Integrating Sphere
21 . . . Light Entrance Port
22 . . . Light Emission Port
23 . . . Sample Placement Unit
24 . . . Optical Fiber
30 . . . Spectroscopic Detection Unit (Light Intensity Measurement Unit)
31 . . . Spectroscope
32 . . . Photodetector
40 . . . Control/Processing Unit
41 . . . Storage Unit
42 . . . Measurement Control Unit
43 . . . Absorbed Photon Number Calculation Unit
48 . . . Input Unit
49 . . . Display Unit
50 . . . Illuminometer

1. A spectrophotometer comprising:
a light source configured to emit light in a wavelength band including an excitation wavelength which causes a photoreaction on a target substance in a sample, the light source emitting a known number of photons of the light having the excitation wavelength;
an integrating sphere having a light entrance port through which light emitted from the light source enters and a light emission port provided at a position deviated from an optical axis of the light entering the light entrance port;
a sample placement unit provided in the light entrance port; and
a light intensity measurement unit configured to measure intensity of light having the excitation wavelength emitted from the light emission port.

2. The spectrophotometer according to claim 1, further comprising
an arithmetic processing unit configured to calculate an absorptivity of the light having the excitation wavelength by the target substance on a basis of the intensity of the light having the excitation wavelength detected by the light intensity measurement unit in a state where the sample is not placed in the sample placement unit and the intensity of the light having the excitation wavelength detected by the light intensity measurement unit in a state where the sample is placed in the sample placement unit.

3. The spectrophotometer according to claim 2, wherein the arithmetic processing unit is further configured to calculate a number of photons of the light absorbed by the target substance on a basis of a number of photons and the absorptivity of the light having the excitation wavelength.

4. The spectrophotometer according to claim 1, wherein
the light source is a white LED light source, and
the light intensity measurement unit includes a spectroscope configured to wavelength-separate light emitted from the light emission port, and a detector configured to detect the light wavelength-separated by the spectroscope.
